(19) United States
(12) Patent Application Publication
(10) Pub. No.: US 2018/0373339 A1
(43) Pub. Date: Dec. 27, 2018

(54) VIBROTACTILE INTERACTION WITH TOUCH-BASED USER DEVICES

(71) Applicant: THOMSON Licensing, Issy les Moulineaux (FR)

(72) Inventors: Kent LYONS, Mountain View, CA (US); Hasti SEIFI, Vancouver (CA)

(21) Appl. No.: 16/063,882

(22) PCT Filed: Dec. 31, 2015
(86) PCT No.: PCT/US2015/068293

§ 371 Date: Jun. 19, 2018

(51) Int. Cl. G06F 3/01; G06F 3/0488; G06F 3/0486

(52) U.S. Cl. CPC G06F 3/016; G06F 3/0486; G06F 3/017; G06F 3/04883

(57) ABSTRACT

A method, user device, and touch surface that generate vibrotactile feedback include: identifying (810) an input event; and iteratively, until the input event is terminated: analyzing (820) the input event to generate a set of input parameter values; generating (830) a vibrotactile response based on the input parameter values; and determining (860) whether the input event has terminated.

### BACKGROUND

Many consumers use wearable or other mobile devices. Such devices may be obtrusive or otherwise negatively affect various situations when the user may want to interact with the device.

Existing solutions, such as variable friction approaches, do not allow for feedback at a static position. In addition, existing solutions utilize touch as a gating function or under pre-defined circumstances that fail to allow for adaptive feedback.

Thus, there is a need for solutions that allow for stationary interactions, adaptive responses, and use of a single input stream.

### SUMMARY

Some embodiments may provide ways to interact with user devices using vibrotactile feedback. Such user devices may include devices with at least one touch-based input element and at least one vibrotactile actuator. Examples of user devices include wearable devices such as smartwatches, mobile devices such as smartphones or tablets, and/or other appropriate devices (e.g., surface displays).

In some embodiments, touch events may be identified and vibrotactile responses may be generated based on the event. Event parameters may include, for instance, location, movement speed, path, pressure, and/or other relevant parameters. The event parameters may be analyzed to identify various input commands.

As the input parameters vary, the vibrotactile response may be modified. Such modification may include live mapping or rendering of the vibrotactile landscape during an ongoing interaction (e.g., as a touch-and-drag operation is performed).

Such live rendering may be based on changes in the various parameters. For instance, a reduction in movement speed may cause a different feedback interface to be rendered.

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates an exemplary user interaction and associated response profile for a message resource according to some embodiments;

FIG. 2 illustrates another exemplary user interaction and associated response profile for a message resource according to some embodiments;

FIG. 3 illustrates an exemplary user interaction for a mood and activity resource according to some embodiments;

FIGS. 4A-4B illustrate exemplary user interactions and associated response profiles for a calendar resource according to some embodiments;

FIG. 5 illustrates an exemplary user interaction and associated response profile for another calendar resource according to some embodiments;

FIG. 6 illustrates an exemplary user interaction for a reporting resource according to some embodiments;

FIG. 7 illustrates an exemplary user interaction for an electronic message resource according to some embodiments;

FIG. 8 illustrates a flow chart of an exemplary process of some embodiments that provides vibrotactile feedback during a user interaction;

FIG. 9 illustrates a flow chart of an exemplary process of some embodiments that analyzes received inputs during a user interaction;

FIG. 10 illustrates a flow chart of an exemplary process of some embodiments that generates feedback during a user interaction; and

FIG. 11 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to generate vibrotactile feedback.

Touch inputs may be monitored, analyzed, and appropriate feedback generated based on the inputs. Such inputs may include parameters such as speed, path, pressure, etc. Feedback may be provided as sets of vibrations. Such vibrations may be specified using various different frequencies, intensities, durations, and/or other appropriate factors.

A first exemplary embodiment provides a method that generates vibrotactile feedback. The method includes: identifying an input event; and iteratively, until the input event is terminated: analyzing the input event to generate a set of input parameter values; generating a vibrotactile response based on the input parameter values; and determining whether the input event has terminated.

A second exemplary embodiment provides a user device that generates vibrotactile feedback. The user device includes: a processor for executing sets of instructions; and a memory that stores the sets of instructions, wherein the sets of instructions include: identifying an input event; and iteratively, until the input event is terminated: analyzing the input event to generate a set of input parameter values; generating a vibrotactile response based on the input parameter values; and determining whether the input event has terminated.

A third exemplary embodiment provides a touch surface that generates vibrotactile feedback. The touch surface includes: a processor for executing sets of instructions; and a memory that stores the sets of instructions, wherein the sets of instructions include: identifying an input event; and iteratively, until the input event is terminated: analyzing the input event to generate a set of input parameter values; generating a vibrotactile response based on the input parameter values; and determining whether the input event has terminated.

Several more detailed embodiments are described in the sections below. Section I provides a description of various exemplary interaction scenarios. Section II then describes exemplary methods of operation used by some embodiments. Lastly, Section III describes a computer system which implements some of the embodiments.

### I. Exemplary Interactions

Although the interactions described below may be presented in reference to a wearable device such as a smartwatch, one of ordinary skill in the art will recognize that various devices may be utilized in similar ways. Such devices may include any device with vibrotactile capabilities (e.g., a smartphone, a smartwatch, a tablet, etc.). In addition, although the examples that follow may use various icons and other graphics, some embodiments provide interaction without any such elements (i.e., a user may see a white screen or watch face during use).

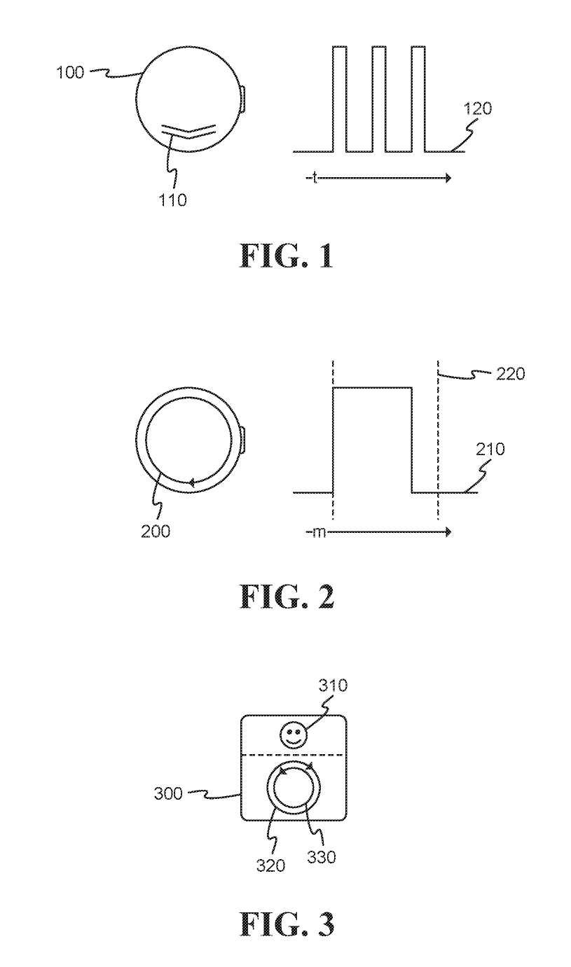

FIG. 1 illustrates an exemplary user interaction and associated response profile for a message resource according to some embodiments. In this example, the interaction is carried out using a watch type user device 100. As shown, a double-tap-and-hold gesture 110 may activate a response 120 indicating a number of received messages. In this example, the response includes three vibration pulses, indicating that the user has received three new messages.

The user device 100 may include a touchscreen that covers the entire face. Different types of devices may include differently arranged input elements (e.g., touch screens, buttons, keypads, etc.).

FIG. 2 illustrates another exemplary user interaction and associated response profile for a message resource according to some embodiments. In this example, a circular gesture 200 generates a response 210 that indicates the time since the last new message was received. The time may be indicated as a percentage of an hour, with an hour represented by a full circle (noted by markers 220 on the response). The markers may correspond to twelve o'clock on the watch face, the start position of the gesture, etc., with the x-axis representing motion along the gesture. In this example, the vibration lasts for seventy-five percent of the circle gesture 200, indicating that the last new message was received forty-five minutes ago.

FIG. 3 illustrates an exemplary user interaction for a mood and activity resource according to some embodiments. In this example, the device 300 has a rectangular shape. Various devices may have various specific shapes or orientations (and associated user interaction resources).

As shown, a touch and hold gesture in a first area may cause a vibrotactile icon to be rendered. Such an icon may be used to indicate overall mood. The vibrotactile icon may include various combinations of pulses, vibration intensities, durations, etc., such that a user is able to differentiate among a set of associated indicators or values.

In addition, a clockwise circle gesture 320 may be associated with a health level, while a counter-clockwise circle gesture 330 may be associated with an activity level. Such levels may be indicated in a similar manner to that described above in respect to FIG. 2.

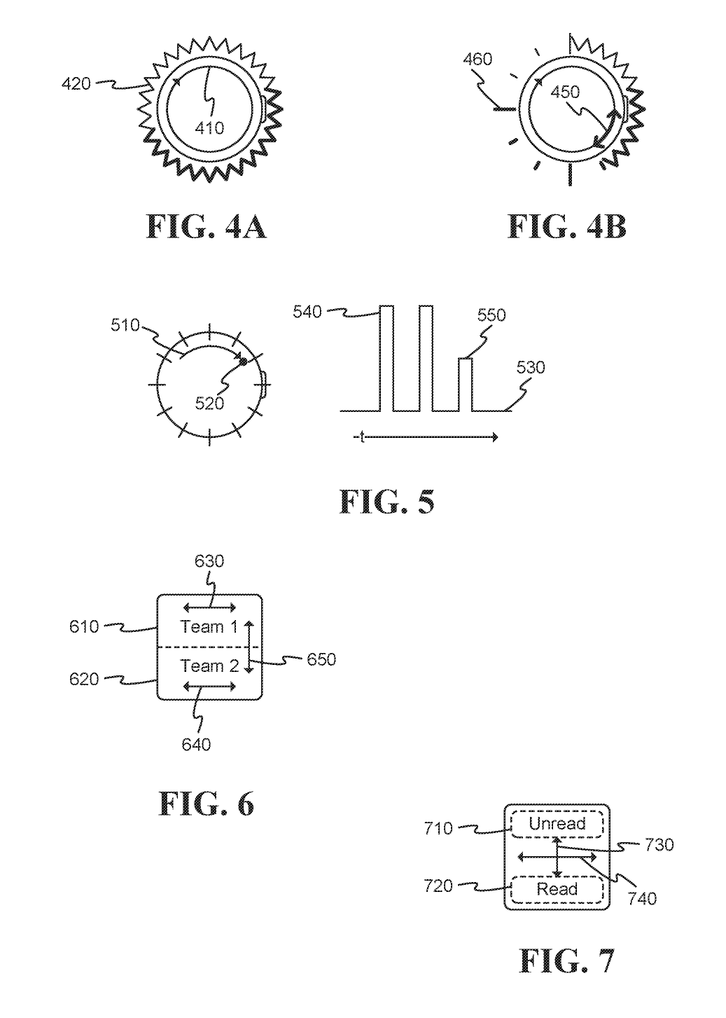

FIG. 4A illustrates an exemplary user interactions and associated response profile for a calendar resource according to some embodiments. In this example, a circular input gesture 410 may cause a response 420. The response is indicated relative to the position along the input gesture 410. In this example, the response 420 includes a low intensity vibration (indicated by the triangle wave) and a high intensity vibration (indicated by the bold wave). The frequency of vibration may remain constant. Alternatively, the intensity may remain constant with the frequency is varied (and/or both parameters may be varied).

The high intensity vibration may be associated with busy periods over the next hour, while the low intensity vibration may be associated with free periods. In some embodiments, the gesture may be continued for multiple iterations. In this example, each circular rotation may move forward to the next hour in the calendar. A continuous response may be generated as long as the gesture is maintained.

FIG. 4B illustrates an exemplary user interaction and associated response profile for a calendar resource according to some embodiments. This interaction may be a continuation of the interaction of FIG. 4A. As shown in FIG. 4B, a rub-gesture may be used to invoke an alternative feedback profile. The alternative response 460 may include a high or low intensity vibration at each of the twelve hour markers, with high intensity indicating busy and low intensity indicating free time.

In some embodiments, the speed of the gesture may alter the associated response. For instance, if a circular gesture 410 is received after a rub gesture 450, the speed of the circular gesture 410 may change the number of markers associated with the response 460. For instance, in some embodiments, slow movement may generate feedback for twelve markers corresponding to five minute intervals, while fast movement generates feedback for four markers, corresponding to fifteen minute intervals.

FIG. 5 illustrates an exemplary user interaction and associated response profile for another calendar resource according to some embodiments. In this example, the gesture 510 moves along an arc until a stop and hold 520. After a threshold stop time has been reached, the response 530 may include high intensity 540 and/or low intensity vibration pulses that correspond to the number of free and busy hours included in the gesture 510.

FIG. 6 illustrates an exemplary user interaction for a reporting resource according to some embodiments. In this example, a top area 610 may be associated with a first team and a second area 620 with a second team that are competing in a sporting event. Within either section, a horizontal gesture 630 or 640 may be used to determine each team's score. For instance, each swipe may receive a buzz until that team's score is reached, at which point no feedback is generated. Different vibrations may be associated with different score amounts (e.g., ten points, one point, etc.). A vertical gesture 650 may generate a response indicating the difference between the teams. In such a case, a first type of response (e.g., low intensity) may indicate a lead for the team associated with area 620 while another type of response (e.g., high intensity) may indicated a lead for the team associated with area 610.

FIG. 7 illustrates an exemplary user interaction and associated response profile for an electronic message resource according to some embodiments. In this example, a touch and hold within a first region 710 may generate a response indicating the number of unread messages (e.g., a number of pulses). Touching a second region 720 may result in a response indicating the number of read messages. Such regions may represent various different categories of messages or other elements (e.g., important, unread, from specified contacts, etc.). If a drag gesture 730 is identified, an indication of urgency may be presented as the gesture is moved down along the face of the device. A drag to the left may generate a rhythm associated with a contact while a drag to the right may generate a number of pulses indicating time of receipt (e.g., two pulses may indicate a message received two hours ago). If the gesture is continued from area 710 to area 720, the gesture may be marked as read and removed from the unread queue. Another gesture may be used to evaluate the next message in the unread area 710 queue. Such gestures may be continued until an appropriate ending criteria is met (e.g., release of the screen, a stop in a specified area, etc.).

One of ordinary skill in the art will recognize that the above examples may be implemented in various appropriate ways without departing from the scope of the disclosure. For instance, although various examples referred to circular gestures, different embodiments may use different gesture shapes (e.g., rectangles, triangles, etc.) and/or patterns. In addition, various different feedback responses may be utilized (e.g., sets of pulses, variable intensity pulses, variable duration pulses, etc.).

### II. Methods of Operation

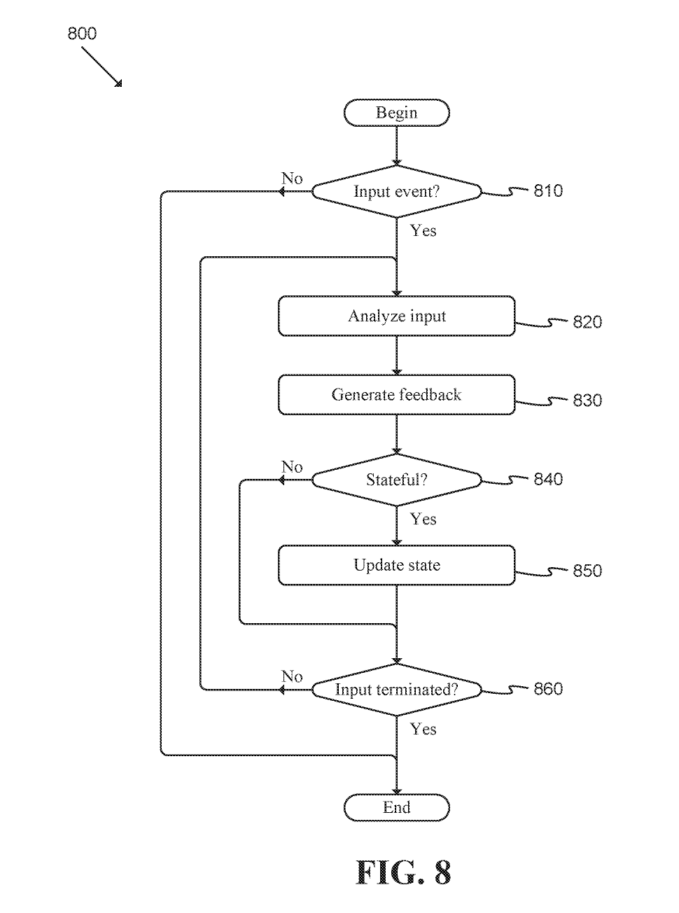

FIG. 8 illustrates a flow chart of an exemplary process 800 of some embodiments that provides vibrotactile feedback during a user interaction. Such a process may be executed by a device such as device 100 described above. The process may begin, for instance, when an application is launched or when the device is powered on.

As shown, the process may determine (at 810) whether an input event has occurred. Such a determination may be made based on various relevant factors (e.g., pressure threshold, touch action, etc.). If the process determines that no even has occurred, the process may end.

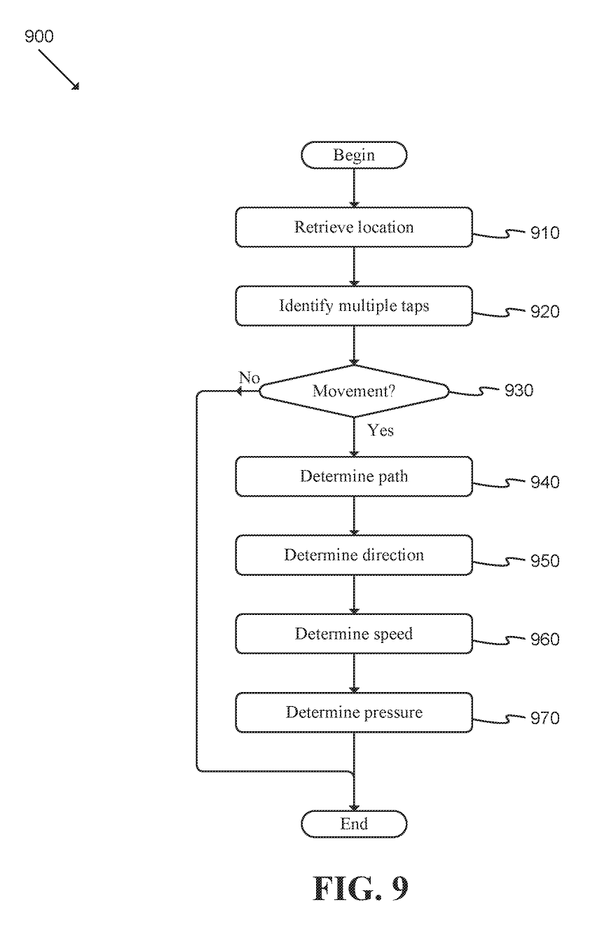

If the process determines that an event has occurred, the process may analyze (at 820) the received input. The analysis may include matching the received input to various criteria (e.g., gesture shape, speed, pressure, etc.) specified in a gesture profile. Such analysis will be described in more detail in reference to FIG. 9 below.

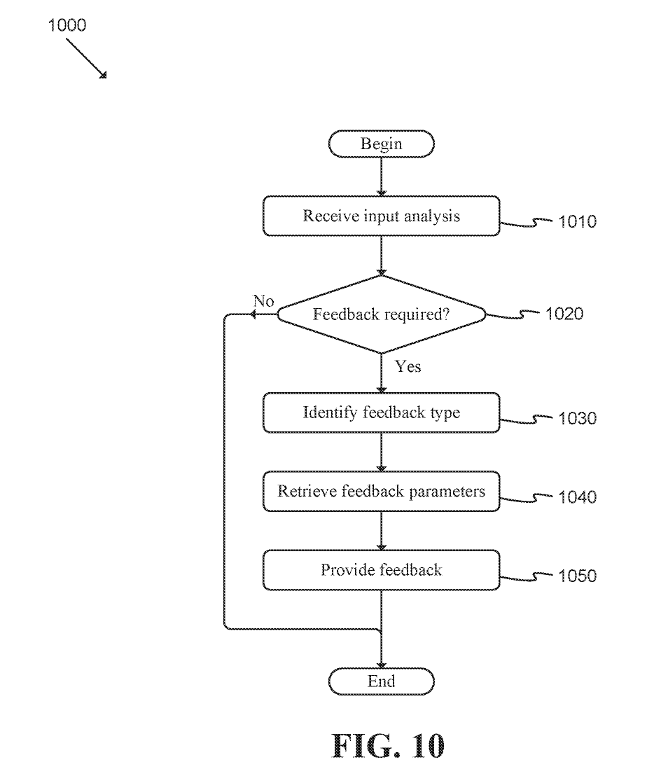

Next, process 800 may generate (at 830) feedback based on the analysis. Such feedback may be specified by the gesture profile in some embodiments (e.g., a gesture may be associated with a feedback type, pattern, etc.). Feedback generation will be described in more detail in reference to FIG. 10 below.

Process 800 may then determine (at 840) whether a current application or resource is stateful. If the process determines that the resource is stateful, the process may update (at 850) the state. Such stateful implementations may include, for instance, incrementing a calendar hour as circular gestures are completed, incrementing a team score as swipe motions are identified, etc.

The process may then determine (at 860) whether the input event has terminated. Such a determination may be based on various relevant factors such as release of touch (e.g., using a pressure threshold), release of touch for a threshold duration, stopping motion, etc.

If the process determines that the event has not been terminated, operations 820-860 may be repeated until the process determines that the input has terminated and then may end. In this way, a continuous user experience may be provided. For instance, a gesture may include multiple iterations of a shape that progressively increment a state (e.g., calendar hour). As another example, movement speed may be associated with varying responses (e.g., a number of increments may be modified based on increased or decreased speed). Other attributes (e.g., pressure, direction, etc.) may be used to control or modify the responses.

FIG. 9 illustrates a flow chart of an exemplary process 900 of some embodiments that analyzes received inputs during a user interaction. Such a process may be performed by a device such as device 100 described above. The process may be performed when an input event is identified as described above in reference to process 800.

As shown, the process may retrieve (at 910) a location of the touch event. Such a location may be retrieved from an element such as a touchscreen.

Next, the process may identify (at 920) whether multiple taps (e.g., two or more touches occurring within some specified length of time) have occurred.

Process 900 may then determine (at 930) whether movement has occurred. If the process determines that no movement has occurred, the process may end. The process may return gesture information indicating a number of taps and a hold status, or some appropriate information depending on the event.

If the process determines that movement has occurred, the process may determine (at 940) a movement path (e.g., circular, square, linear, etc.), determine (at 950) a direction of movement (e.g., clockwise or counterclockwise, up or down, left or right, etc.), determine (at 960) a speed of movement (e.g., a value within a range, a discrete value within a set of values (e.g., slow, fast, etc.), etc.), and determine (at 970) a pressure (e.g., a value within a range, a discrete value (e.g., active touch, touch released, etc.) associated with the movement, and then may end. Some embodiments may determine pressure regardless of whether movement is detected (e.g., a gesture may be associated with changes in pressure at a static location).

Different embodiments may determine various other additional and/or different attributes or parameters. The identified attributes may be used to determine an input gesture in some embodiments. Such gestures may include, for instance, shapes (e.g., circle, rectangle, etc.), specified motions (e.g., rub, swipe, etc.), changes to movement or other input parameters (e.g., reduction in speed, increase in pressure, etc.).

The process may return information related to the direction, speed, pressure, etc. In some embodiments, the received inputs may be matched to a gesture profile. In such cases, the profile identification may be returned.

FIG. 10 illustrates a flow chart of an exemplary process 1000 of some embodiments that generates feedback during a user interaction. Such a process may be performed by a device such as device 100 described above. The process may be performed after analyzing some input as described above in reference to process 900.

As shown, the process may receive (at 1010) the input analysis. Such analysis may include a variety of attributes (e.g., direction, speed, pressure, etc.). Each attribute may be associated with a specified value. For example, a numeric value may represent an amount associated with the attribute. Some attributes may be associated with a state value such as “active touch”, “movement stopped”, etc. In some cases, the input analysis may include an identifier of a gesture profile and/or feedback element. Such information may include various parameters and/or value that may at least partly control the generation of the feedback.

Next, the process may determine (at 1020) whether feedback is required. Such a determination may be made depending on the received input analysis, profile information, and/or received parameters. If the process determines that no feedback is required (e.g., when no messages have been received), the process may end.

If the process determines that feedback is required, the process may identify (at 1030) the feedback type and retrieve (at 1040) the associated parameters. Such identification and parameters may be received (at 1010) in some embodiments. The parameters may include parameters related to the feedback (e.g., vibration intensity, frequency, duration, number of pulses etc.), user (e.g., user selections or parameters related to preferred feedback types or options), etc. After retrieving (at 1040) the parameters, the process may generate (at 1050) the feedback and then end. Feedback generation may include sending information to a vibrotactile actuator such as frequency, intensity, duration, etc.

One of ordinary skill in the art will recognize that processes 800-1000 may be implemented in various different ways without departing from the scope of the disclosure. For instance, some operations may be omitted and/or other operations may be included. As another example, the operations may be performed in a different order. In addition, each process may be divided into multiple sub-processes and/or included as part of a larger macro process.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

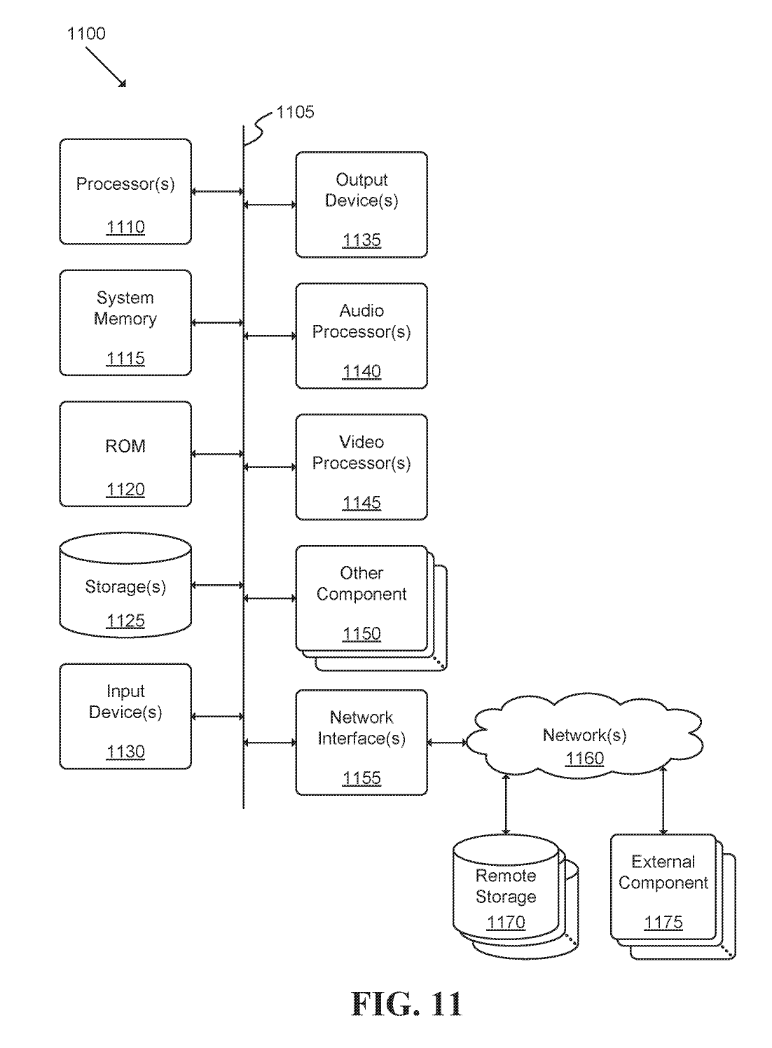

FIG. 11 illustrates a schematic block diagram of an exemplary computer system 1100 used to implement some embodiments. For example, the devices described above in reference to FIGS. 1-7 may be at least partially implemented using computer system 1100. As another example, the processes described in reference to FIGS. 8-10 may be at least partially implemented using sets of instructions that are executed using computer system 1100.

Computer system 1100 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 1100 may include at least one communication bus 1105, one or more processors 1110, a system memory 1115, a read-only memory (ROM) 1120, permanent storage devices 1125, input devices 1130, output devices 1135, audio processors 1140, video processors 1145, various other components 1150, and one or more network interfaces 1155.

Bus 1105 represents all communication pathways among the elements of computer system 1100. Such pathways may include wired, wireless, optical, and/or other appropriate communication pathways. For example, input devices 1130 and/or output devices 1135 may be coupled to the system 1100 using a wireless connection protocol or system.

The processor 1110 may, in order to execute the processes of some embodiments, retrieve instructions to execute and/or data to process from components such as system memory 1115, ROM 1120, and permanent storage device 1125. Such instructions and data may be passed over bus 1105.

System memory 1115 may be a volatile read-and-write memory, such as a random access memory (RAM). The system memory may store some of the instructions and data that the processor uses at runtime. The sets of instructions and/or data used to implement some embodiments may be stored in the system memory 1115, the permanent storage device 1125, and/or the read-only memory 1120. ROM 1120 may store static data and instructions that may be used by processor 1110 and/or other elements of the computer system.

Permanent storage device 1125 may be a read-and-write memory device. The permanent storage device may be a non-volatile memory unit that stores instructions and data even when computer system 1100 is off or unpowered. Computer system 1100 may use a removable storage device and/or a remote storage device as the permanent storage device.

Input devices 1130 may enable a user to communicate information to the computer system and/or manipulate various operations of the system. The input devices may include keyboards, cursor control devices, audio input devices and/or video input devices. Output devices 1135 may include printers, displays, audio devices, etc. Some or all of the input and/or output devices may be wirelessly or optically connected to the computer system 1100.

Audio processor 1140 may process and/or generate audio data and/or instructions. The audio processor may be able to receive audio data from an input device 1130 such as a microphone. The audio processor 1140 may be able to provide audio data to output devices 1140 such as a set of speakers. The audio data may include digital information and/or analog signals. The audio processor 1140 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 1145 (or graphics processing unit) may process and/or generate video data and/or instructions. The video processor may be able to receive video data from an input device 1130 such as a camera. The video processor 1145 may be able to provide video data to an output device 1140 such as a display. The video data may include digital information and/or analog signals. The video processor 1145 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 1150 may perform various other functions including providing storage, interfacing with external systems or components, etc. In addition, such other components may include vibrotactile elements of some embodiments.

Finally, as shown in FIG. 11, computer system 1100 may include one or more network interfaces 1155 that are able to connect to one or more networks 1160. For example, computer system 1100 may be coupled to a web server on the Internet such that a web browser executing on computer system 1100 may interact with the web server as a user interacts with an interface that operates in the web browser. Computer system 1100 may be able to access one or more remote storages 1170 and one or more external components 1175 through the network interface 1155 and network 1160. The network interface(s) 1155 may include one or more application programming interfaces (APIs) that may allow the computer system 1100 to access remote systems and/or storages and also may allow remote systems and/or storages to access computer system 1100 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1100 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

1. A method that generates vibrotactile feedback, the method comprising:
identifying (810) an input event; and
iteratively, until the input event is terminated:
analyzing (820) the input event to generate a set of input parameter values;
generating (830) a vibrotactile response based on the input parameter values; and
determining (860) whether the input event has terminated.

2. The method of claim 1, wherein analyzing the input event comprises:
identifying a location associated with the input event;
identifying a number of taps associated with the input event;
determining a pressure associated with the input event; and
determining a set of movement attribute values.

3. The method of claim 2, wherein the set of movement attribute values are associated with at least one movement attribute from among speed, direction, and path.

4. The method of claim 1, wherein analyzing the input event comprises identifying a gesture associated with the set of input parameter values, wherein the gesture comprises one of:
a clockwise circle;
a counterclockwise circle;
a tap-and-hold;
a rub; and
a tap-and-drag.

5. The method of claim 1, wherein generating the vibrotactile response comprises:
identifying a feedback type based on the input parameter values;
retrieving a set of feedback parameters based on the feedback type; and
providing the vibrotactile response based on the set of feedback parameters.

6. The method of claim 1, wherein the vibrotactile response comprises at least one of:
a first set of pulses having a first intensity;
a second set of pulses having a second intensity;
a continuous vibration having a fixed frequency and at least two intensity levels; and
a pulse having a duration proportional to a value, wherein the duration is relative to an input gesture.

7. The method of claim 1 further comprising iteratively, until the input event is terminated, updating a state based on analysis of the input event.

8. A user device that generates vibrotactile feedback, the user device comprising:
a processor for executing sets of instructions; and
a memory that stores the sets of instructions, wherein the sets of instructions comprise:
identifying (810) an input event; and
iteratively, until the input event is terminated:
analyzing (820) the input event to generate a set of input parameter values;
generating (830) a vibrotactile response based on the input parameter values; and
determining (860) whether the input event has terminated.

9. The user device of claim 8, wherein analyzing the input event comprises:
identifying a location associated with the input event;
identifying a number of taps associated with the input event;
determining a pressure associated with the input event; and
determining a set of movement attribute values.

10. The user device of claim 9, wherein the set of movement attribute values are associated with at least one movement attribute from among speed, direction, and path.

11. The user device of claim 8, wherein analyzing the input event comprises identifying a gesture associated with the set of input parameter values, wherein the gesture comprises one of:
a clockwise circle;
a counterclockwise circle;
a tap-and-hold;
a rub; and
a tap-and-drag.

12. The user device of claim 8, wherein generating the vibrotactile response comprises:
identifying a feedback type based on the input parameter values;
retrieving a set of feedback parameters based on the feedback type; and
providing the vibrotactile response based on the set of feedback parameters.

13. The user device of claim 8, wherein the vibrotactile response comprises at least one of:
a first set of pulses having a first intensity;
a second set of pulses having a second intensity;
a continuous vibration having a fixed frequency and at least two intensity levels; and
a pulse having a duration proportional to a value, wherein the duration is relative to an input gesture.

14. The user device of claim 8, wherein the sets of instructions further comprise, iteratively, until the input event is terminated, updating a state based on analysis of the input event.

15. A non-transitory computer-readable medium storing computer-executable program instructions for performing a method of generating vibrotactile feedback, the method comprising:
identifying (810) an input event; and
iteratively, until the input event is terminated:
analyzing (820) the input event to generate a set of input parameter values;
generating (830) a vibrotactile response based on the input parameter values; and
determining (860) whether the input event has terminated.

16. The non-transitory computer-readable medium of claim 15, wherein analyzing the input event comprises:
identifying a location associated with the input event;
identifying a number of taps associated with the input event;
determining a pressure associated with the input event; and
determining a set of movement attribute values.

17. The non-transitory computer-readable medium of claim 16, wherein the set of movement attribute values are associated with at least one movement attribute from among speed, direction, and path.

18. The non-transitory computer-readable medium of claim 15, wherein analyzing the input event comprises identifying a gesture associated with the set of input parameter values, wherein the gesture comprises one of:
a clockwise circle;
a counterclockwise circle;
a tap-and-hold;
a rub; and
a tap-and-drag.

19. The non-transitory computer-readable medium of claim 15, wherein generating the vibrotactile response comprises:
identifying a feedback type based on the input parameter values;
retrieving a set of feedback parameters based on the feedback type; and
providing the vibrotactile response based on the set of feedback parameters.

20. The non-transitory computer-readable medium of claim 15, wherein the vibrotactile response comprises at least one of:
a first set of pulses having a first intensity;
a second set of pulses having a second intensity;
a continuous vibration having a fixed frequency and at least two intensity levels; and
a pulse having a duration proportional to a value, wherein the duration is relative to an input gesture.

21. The non-transitory computer-readable medium of claim 15, the method further comprising iteratively, until the input event is terminated, updating a state based on analysis of the input event.
